(19) United States
(12) Patent Application Publication
(10) Pub. No.: US 2023/0417096 A1
(43) Pub. Date: Dec. 28, 2023

(54) Systems With Closures

(71) Applicant: Apple Inc., Cupertino, CA (US)

(72) Inventors: Arian Behzadi, San Francisco, CA (US); Arto Kivila, Santa Clara, CA (US); Jeffrey A Sewell, Wyandotte, MI (US); Kurt R Stiehl, Los Gatos, CA (US); Andrew W Kooker, San Francisco, CA (US); Athena Y Huang, Palo Alto, CA (US); Kevin S Chan, Cupertino, CA (US)

(21) Appl. No.: 18/193,187

(22) Filed: Mar. 30, 2023

Related U.S. Application Data
(60) Provisional application No. 63/355,920, filed on Jun. 27, 2022.

(51) Int. Cl. E05F 15/46; E05F 15/41

(52) U.S. Cl. CPC E05F 15/46; E05F 15/41; E05Y 2900/531; E05Y 2400/33; E05Y 2400/55

(57) ABSTRACT

A system may have a closure with an electrically controlled actuator. Sensor circuitry may gather user input. The sensor circuitry may include a force sensor, touch sensor, proximity sensor, and/or other sensors. Based on input from the sensor circuitry, the closure may be slid relative to a system body or may otherwise be moved relative to the body. The sensor may receive user input from a user's fingers. This allows the movement of the closure to track user hand motions. To open and close the closure, a user may press against closure edge sensors mounted to edges of the closure. Closure motion may also be controlled by button press input, proximity sensor readings, touch sensor input and/or other user input provided to an input device in the system.

This application claims the benefit of provisional patent application No. 63/355,920, filed Jun. 27, 2022, which is hereby incorporated by reference herein in its entirety.

### FIELD

This relates generally to closures, and, more particularly, controls for closures.

### BACKGROUND

Systems such as buildings may have motorized closures. Buttons may be used to open and close motorized closures.

### SUMMARY

A system may have a closure such as a door or window with an electrically controlled actuator. Sensor circuitry may gather user input. The sensor circuitry may include a force sensor, touch sensor, proximity sensor, and/or other sensors. Based on input from the sensor circuitry, a door may slide relative to a system body or may otherwise move relative to the body. The sensor may receive user input such as force input from a user's fingers. This allows the movement of the door to track user body part motions (e.g., body part gestures such as hand motions, finger and/or thumb motions, etc.). To open and close the door, a user may press against door edge sensors mounted to edges of the door. The door may then be moved in response to continued finger pressure as the user's hand moves with the door. Door motion may also be controlled by button press input, proximity sensor readings, capacitive touch sensor input and/or other input.

### BRIEF DESCRIPTION OF THE DRAWINGS

FIG. 1 is a cross-sectional top view of an illustrative system in accordance with an embodiment.

FIG. 2 is a side view of an illustrative system in accordance with an embodiment.

FIG. 3 is a cross-sectional top view of an illustrative system showing how a system door may be provided with an electrically controlled actuator in accordance with an embodiment.

FIG. 4 is a side view of an illustrative sensor in accordance with an embodiment.

FIGS. 5, 6, 7, 8, and 9 are top views of a system door during opening and closing operations in accordance with embodiments.

FIG. 10 is a flow chart of illustrative operations involved in using sensor circuitry in a system to open and close a system door in accordance with an embodiment.

### DETAILED DESCRIPTION

A mobile system such as a vehicle or other system may have closures such as doors and windows. Electrically controlled actuators may be used to adjust the doors and windows. For example, actuators may be used to open and close doors and windows, may be used to perform locking and unlocking operations, may be used to move a door between a stowed position where the door is flush against a vehicle body or other mobile systems body and a deployed position where the door is proud of the vehicle body or other mobile systems body, etc. Doors and windows may be opened and closed by sliding, rotation (tilting), and/or other suitable actions. Illustrative configurations in which a vehicle is provided with a sliding door with an electrically adjustable actuator may sometimes be described as an example. In general, doors, windows, and/or other vehicle (mobile systems) structures may be moved by electrically adjustable actuators.

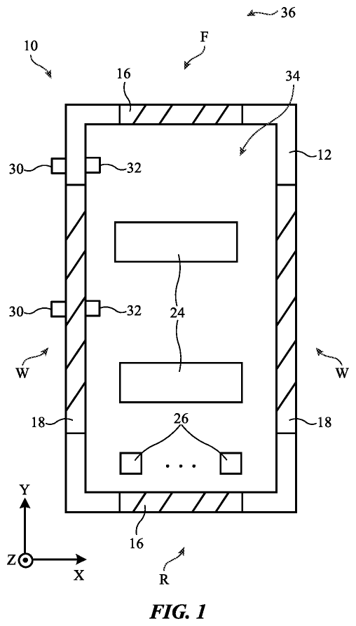

FIG. 1 is a cross-sectional top view of an illustrative mobile system such as a vehicle. In the example of FIG. 1, vehicle 10 is the type of vehicle that may carry passengers (e.g., an automobile, truck, or other automotive vehicle).

Vehicle 10 may be manually driven (e.g., by a human driver), may be operated via remote control, and/or may be autonomously operated (e.g., by an autonomous vehicle driving system implemented using the control circuitry, sensors, and other components of vehicle 10). If desired, a vehicle driving system (e.g., a computer-assisted driving system that is also optionally used to support fully autonomous driving) may be used to provide vehicle driving assistance functions while vehicle 10 is being driven under manual control.

Vehicle 10 may include a body such as body 12. Body 12 may include vehicle structures such as body panels formed from metal and/or other materials, may include doors 18, a hood, a trunk, fenders, a chassis to which wheels are mounted, a roof, etc. Windows 16 may be formed in doors 18 (e.g., on the sides W of vehicle body 12, on the roof of vehicle 10, in body 12 at front F and/or rear R of vehicle 10, and/or in other portions of vehicle 10). Windows 16, doors 18, and other portions of body 12 may separate interior region 34 of vehicle 10 from the exterior environment that is surrounding vehicle 10 (exterior region 34).

Vehicle 10 may have seating such as seats 24 in interior region 34. Seats 24 may include bucket seats, bench seats, and/or other seats on which vehicle occupants may sit. These seats may include forward-facing seats and/or rear-facing seats. In the example of FIG. 1, seats 24 include a pair of face-to-face seats 24 in which first and second seats 24 face each other. In general, seats 24 may be oriented so that one or more users face forward as vehicle 10 is driven forward and so that one or more users face rearward as vehicle 10 is driven forward. Right and left seat occupants may sit adjacent to each other on each seat 24 or each seat 24 may accommodate more passengers or fewer passengers. Arrangements in which the seats of vehicle 10 face to the side, in which all seats 24 face forward, in which seats 24 may be rotated between forward and rearward orientations and/or other orientations, and/or in which seats 24 of vehicle 10 have other configurations may also be used. The configuration of FIG. 1 in which interior region 34 of vehicle 10 contains one or more rearward-facing bucket seats and/or bench seats and one or more forward-facing bucket seats and/or bench seats is illustrative.

Vehicle 10 may be provided with one or more input-output components. These components may include displays, speakers, interior and exterior lights, actuators for adjusting the position and motion of structures in vehicle 10, and input devices that gather user input. The input devices may include proximity sensors, touch sensors, force sensors, buttons, etc. Sensors may also be used in vehicle 10 to make measurements on environmental conditions (e.g., ambient light levels, temperatures, etc.). In some configurations, the input-output components may contain wireless circuitry. The wireless circuitry may include ultrawideband (UWB) circuitry, near-field communications circuitry, Bluetooth® circuitry, wireless local area network circuitry, and/or other wireless circuitry. The wireless circuitry may be used to detect nearby devices (e.g., wireless key fobs, portable electronic devices such as wristwatches and cellular telephones emitting UWB signals and/or other short-range wireless signals, etc.). As an example, wireless circuitry may be used to detect the presence of a nearby electronic device and vehicle 10 may, in response, use an actuator to unlock a door in vehicle 10.

During operation, user input may be used to operate vehicle 10. The input-output components of vehicle 10 may include buttons, sensors, and/or other components that serve as controllers for gathering user input to adjust vehicle operations. These input devices may be used for receiving user steering commands, for receiving user navigation commands for an autonomous driving system, for receiving user input to adjust lighting, media playback, heating and air-conditioning, for receiving input to open and close doors (and windows), for receiving input to lock and unlock doors (and windows), for receiving input to otherwise control doors and/or windows, for receiving input to control other vehicle operations, and for receiving other user input. In an illustrative configuration, vehicle 10 includes sensor circuitry (e.g., a touch sensor, force sensor, proximity sensor, and/or other sensor(s)) to receive commands from users (e.g., vehicle occupants, users approaching vehicle 10 from the outside, etc.). The sensor circuitry may, as an example, include sensors that allow a user to supply user input that directs one or more electrically adjustable actuators to move a door from a stowed to a deployed position, to open and/or close the door, to lock/unlock the door, to open and/or close a window, etc.

As shown in FIG. 1, vehicle 10 of FIG. 1 may include components 26. Components 26 may include control circuitry and input-output devices. Control circuitry and/or input-output devices in components 26 may be configured to operate vehicle systems such as the steering and propulsion system based on user input, to operate vehicle systems such as the steering and propulsion system autonomously in connection with running an autonomous driving application, to run a navigation application (e.g., an application for displaying maps on a display), to run software for controlling vehicle climate control devices, lighting, media playback, window movement, door operations, seating position devices, and/or to support the operation of other vehicle functions. The control circuitry and/or input-output devices (sensor circuitry, other input-output components, etc.) may include processing circuitry and storage and may be configured to perform operations in vehicle 10 using hardware (e.g., dedicated hardware or circuitry), firmware and/or software. Software code for performing operations in vehicle 10 and other data is stored on non-transitory computer readable storage media (e.g., tangible computer readable storage media) in the control circuitry. Remote storage and other remote control circuitry (e.g., circuitry on remote servers, etc.) may also be used in storing the software code. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid state drives), one or more removable flash drives or other removable media, or other storage. Software stored on the non-transitory computer readable storage media may be executed on the processing circuitry of components 26 and/or the processing circuitry of remote hardware such as processors associated with one or more remote servers that communicate with components 26 over wired and/or wireless communications links. The processing circuitry may include application-specific integrated circuits with processing circuitry, one or more microprocessors, a central processing unit (CPU) or other processing circuitry.

The input-output components (input-output devices) of components 26 may include displays, sensors, buttons (e.g., sensors based on movable button members that press against switches), light-emitting diodes and other light-emitting devices for providing interior and/or exterior lighting, haptic devices, speakers, door locks, actuators for moving portions of doors, windows, and/or other components, and/or other devices such as input devices for gathering environmental measurements, information on vehicle operations, and/or user input. The sensors in components 26 may include ambient light sensors, touch sensors, force sensors, proximity sensors (e.g., optical proximity sensors and/or capacitive proximity sensors based on self-capacitance sensors and/or mutual capacitance sensor circuitry), optical sensors such as cameras operating at visible, infrared, and/or ultraviolet wavelengths (e.g., fisheye cameras and/or other cameras), capacitive sensors, resistive sensors, ultrasonic sensors (e.g., ultrasonic distance sensors), microphones, three-dimensional and/or two-dimensional images sensors, radio-frequency sensors such as radar sensors, lidar (light detection and ranging) sensors, door open/close sensors, seat pressure sensors and other vehicle occupant sensors, window sensors, position sensors for monitoring location, orientation, and movement, speedometers, satellite positioning system sensors, and/or other sensors. Output devices in components 26 may be used to provide vehicle occupants and others with haptic output (e.g., force feedback, vibrations, etc.), audio output, visual output (e.g., displayed content, light, etc.), and/or other suitable output. Components 26 may be mounted in interior region 34 and/or exterior region 36 and/or may, if desired, be attached to and/or mounted to other portions of body 12 (sometimes referred to as a mobile systems body). For example, components 26 may be mounted in one or more interior locations such as one or more the locations 32 of FIG. 1 (e.g., one or more location on body 12 in region 34 that is adjacent to door 18 and/or one or more locations on the interior surface of door 18) and may be mounted in exterior locations such as one or more of locations 30 of FIG. 1 (e.g., one or more exterior locations on body 12 adjacent to door 18 and/or one or more locations on the exterior of door 18). Components 26 (e.g., input devices) may also be mounted to the edges of doors 18. In edge-mounted configurations, the components may be hidden from view when door 18 is stowed as shown in FIG. 1.

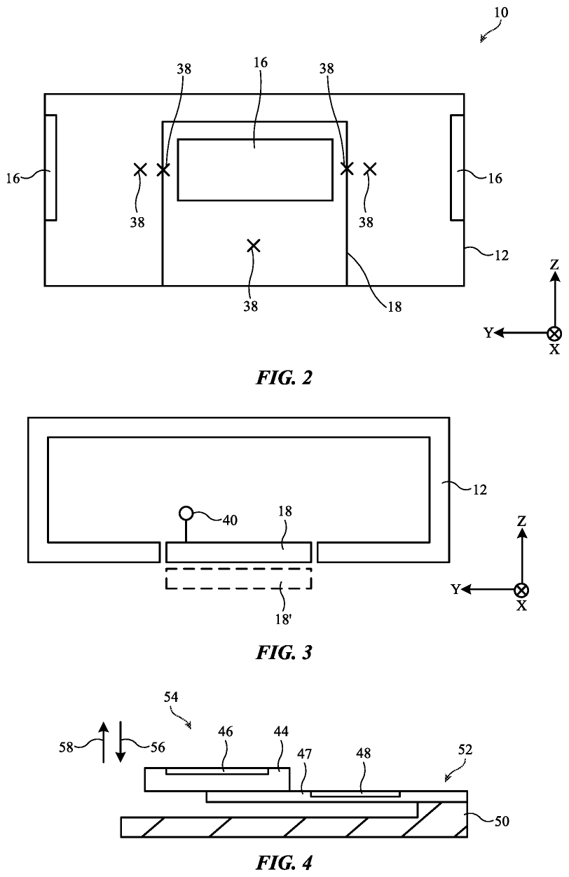

FIG. 2 is a side view of vehicle 10. Components 26 (e.g., lights and/or other output devices, input devices such as buttons, capacitive sensors, proximity sensors, force sensors, and/or other sensors, etc.) may be mounted in locations such as locations 38 (as examples). Locations 38 may be on the outer and/or inner surface of door 18, on one or both edges (sides) of door 18, on vehicle body 12 adjacent to door 18, and/or other suitable locations in vehicle 10.

Doors such as door 18 may or may not include windows such as window 16. Door 18 may be opened by swinging on a hinge that is coupled to body 12 or may be a sliding door that slides along the Y dimension of FIG. 2. Illustrative configurations in which door 18 is a sliding door may sometimes be described herein as an example.

An actuator formed from one or more motors, formed from one or more electromagnetic linear actuators such as solenoids, and/or formed from one or more other positioners (e.g., other electromagnetic actuators) may be used in moving door 18. As shown in the cross-sectional top view of vehicle 10 of FIG. 3, an actuator such as actuator 40 may be used to move door 18 between a stowed position (e.g., the position of FIG. 3 in which the outer surface of door 18 is flush with the adjacent outer surface of body 12) to a deployed position in which door 18 is proud of the surface of vehicle body 12. Actuator 40 may, as an example, move door 18 outwardly in the −Z direction of FIG. 3 to deployed position 18′ and may, when it is desired to stow door 18, retract door 18 along the Z direction to the stowed position of FIG. 3. Door 18 may also have a lock. The lock may have a solenoid or other actuator that allows the lock to be locked and unlocked electronically.

Vehicle occupants may lock door 18. A user in the interior of vehicle 10 who desires to exit vehicle 10 after vehicle 10 has been parked may supply user input to an input device in the interior of vehicle 10 that directs door 18 to unlock and may supply user input to an input device in the interior of vehicle 10 that directs door 18 to open. In general, any suitable user input may be used to direct door 18 to unlock and/or open. For example, this user input may include button press input to a button, touch input to a capacitive touch sensor, force input to a force sensor, gesture input to a gesture sensor (e.g., an optical gesture sensor that detects user body part motions such as hand motions and/or finger and/or thumb motions or other user input at a distance), voice input to a microphone, biometric input such as eye input to an iris scanner or a gaze tracker, fingerprint input to a fingerprint sensor, facial input to a facial sensor, and/or other user input detected by an input device (e.g., a capacitive sensor, a camera such as a visible light image sensor, and/or an infrared light image sensor, a microphone, a force sensor, a button, and/or other sensor(s)).

Actuator 40 may then move door 18 to position 18′. After reaching position 18′, door 18 may be automatically opened by actuator 40 (e.g., by sliding door 18 parallel to the side of vehicle 10) or door 18 may be opened in response to further user input (a single touch input, persistent touch and/or force input, etc.) which is detected by a sensor (e.g., a sensor on the side of door 18, a sensor in the interior of vehicle 10, etc.).

When vehicle 10 is parked, a user who has exited vehicle 10 may lock door 18. When the user returns to vehicle 10, door 18 may be unlocked by the user. Vehicle 10 may, as an example, use wireless circuitry to detect radio-frequency signals (e.g., beacons) being transmitted from a key fob or portable electronic device in the user's possession. If desired, cameras and/or other sensors such as a capacitive proximity sensor may also be used to detect the presence of the user in the vicinity of vehicle 10. In some embodiments, a camera may be used to track a user's path to determine which of multiple vehicles the user is walking towards so that the appropriate vehicle in a user's garage may respond to the user's presence and/or a camera or other sensor may be used to biometrically authenticate the user (e.g., by facial recognition, voice recognition, fingerprint recognition, etc.). In response to detecting a wireless unlock command from a user's key fob or other device or in response to detection of the user in proximity to vehicle 10 (and if desired user authentication), vehicle 10 may unlock door 18 and/or take other suitable action (e.g., by activating exterior lighting such as one or more light sources on the exterior of vehicle 10 that illuminate the exterior region around vehicle 10 in the vicinity of door 18, by deploying door 18 from the stowed position, etc.).

After unlocking door 18, door 18 may automatically be moved by actuator 40 from its stowed position to deployed position 18′ or door 18 may be deployed to position 18′ by actuator 40 in response to user input from the user. For example, door 18 may be automatically deployed in response to detecting that the user is in proximity to vehicle 10 or may be deployed when a user supplies user input to a sensor on the exterior of door 18, a sensor on a portion of the exterior of body 12 that is adjacent to door 18, a sensor on or near a door handle, a button, etc. In some configurations, door 18 may be made of a conductive material such as metal and may serve as a capacitive touch sensor electrode that detects user touch input.

User input that is used to deploy door 18 may, in general, include button press input to a button, touch input to a capacitive touch sensor, force input to a force sensor, gesture input to a gesture sensor (e.g., an optical gesture sensor that detects user body part motions such as hand motions and/or finger and/or thumb motions or other user input at a distance), voice input to a microphone, biometric input such as eye input to an iris scanner or a gaze tracker, fingerprint input to a fingerprint sensor, facial input to a facial sensor ,and/or other user input detected by an input device (e.g., a capacitive sensor, a camera such as a visible light image sensor and/or an infrared light image sensor, a force sensor, a button, a microphone, and/or other sensor(s)).

Once door 18 has been deployed, a user may supply user input to direct vehicle 10 to move door 18 (e.g., to open door 18 with actuator 40). For example, the user may supply user input to an input device adjacent to door 18 (e.g., a button, a touch sensor, a proximity sensor, a microphone that gathers user voice input, etc.). In another illustrative configuration, the left and right edges of door 18 are provided with sensors. These sensors are hidden by mating edges of body 12 when door 18 is stowed, but are exposed and available to the user when door 18 is deployed into position 18′ of FIG. 3. Using the door edge sensors, the user may slide the door open and closed. For example, to slide door 18 to the left, the user may supply finger press input to the right-hand door edge sensor and to slide door 18 to the right, the user may supply finger press input to the left-hand door edge sensor.

Any suitable sensors in components 26 may be used as door edge sensors. An illustrative configuration for a door edge sensor that includes touch sensing and force sensing capabilities is shown in FIG. 4. In the example of FIG. 4, sensor 42 includes capacitive touch sensor 54 mounted on bendable member 47. Sensor 54 has a capacitive touch sensor electrode 46 on a substrate 44 (e.g., a printed circuit). Capacitance sensing circuitry that is coupled to electrode 46 may monitor for changes in capacitance indicative of user contact with electrode 46. Touch sensor 54 allows a user to provide touch input without exerting significant force on sensor 42. For example, a user may lightly contact electrode 46 to provide finger touch input (e.g., to direct door 18 to open or close without further input from the user). Sensor 42 also serves as a force sensor. As shown in FIG. 4, bendable (flexible) member 47 may be attached to support structure 50 at end 52 (e.g., the opposite end of member 47 from sensor 54). Strain gauge circuitry 48 may be mounted on member 47 to detect force input to sensor 42. When, for example, a user's finger presses downward on electrode 46 in direction 56, the end of member 47 that is supporting sensor 54 will bend downwardly. Strain gauge circuitry 48 measures the amount of resulting strain in member 47 and therefore measures the amount of force exerted by the user in direction 56. When the user removes the user's finger from sensor 42, member 47 may exhibit a restoring force in upwards direction 58 that causes member 47 to return to its original unbent shape.

Using sensor 42 of FIG. 4, a user may supply either gentle input (e.g., touch input measured by the capacitive touch sensing circuitry of sensor 42) or may supply stronger force input (e.g., a force that is measured by sensor 42 as exceeding a predetermined minimum force level threshold). The presence of persistent user input from a user's body part (e.g., a user's finger) such as touch or force input may be used to open and close door 18. In a first embodiment, a user who desires to open or close door 18 may persistently touch sensor 54 on the right or left edge of door 18, without regard to the amount of finger force being supplied. In response, door 18 may move to the left or right, respectively, only stopping if touch input is interrupted by removal of a user's finger or if a door edge sensor or other sensor on door 18 detects contact with or close proximity to an obstruction. In a second embodiment, a user who desires to open or close door 18 supplies force input to the door edge sensor (e.g., force input that is detected using strain gauge circuitry 48 or other force sensor circuitry such as capacitive force sensor circuitry, resistive force sensor circuitry, etc.). So long as sensor 42 is supplied with force input, door 18 may be moved by actuator 40 (e.g., door 18 may be moved in the direction in which the force input is applied). The door may be opened at a constant velocity (e.g., so long as the input force exceeds a predetermined threshold amount) or may be opened at a velocity that varies (e.g., a velocity that increases as a function of increasing applied force and that decreases when less force is measured). The velocity at which the door opens may, as an example, vary to maintain the user's force on the door at or near a predetermined fixed force value. In this way, the user may supply a relatively light force on a door edge sensor and the door will automatically track the user's finger and hand as the user moves the user's finger and hand in the direction in which it is desired to move the door. This may allow for the use of natural door opening and closing arm motions (and associated natural hand, finger, and thumb motions) by the user. For example, if the user desires to slide the door to the left to open the door, the user may supply leftwards force input to the right-hand door edge sensor mounted on a right edge of the door and actuator 40 of door 18 will automatically move the door to the left, tracking the user's leftward motion (e.g., adjusting the velocity of the door to the velocity of the user's arm, hand, finger, and/or thumb).

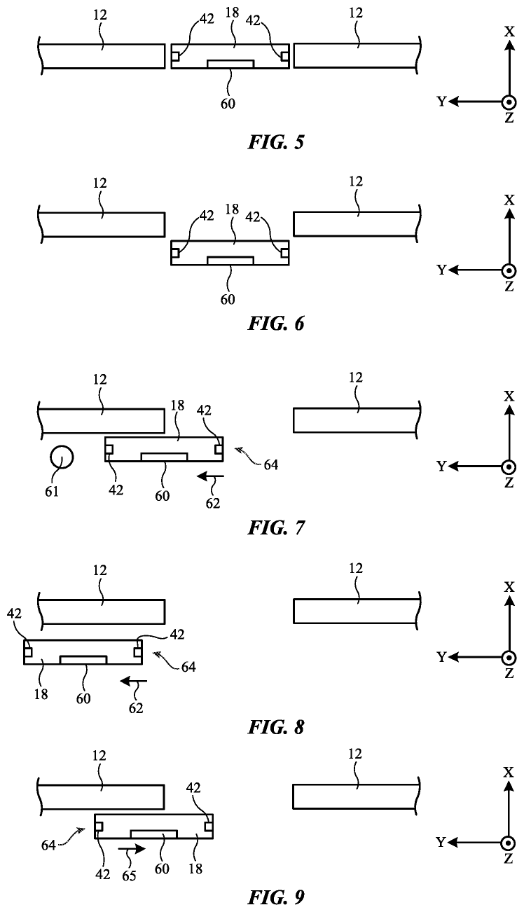

FIGS. 5, 6, 7, 8, and 9 are top views of a portion of a vehicle with a door that is being opened and closed.

As shown in FIG. 5, door 18 may include a first sensor such as a first one of sensors 42 (sometimes referred to as a left edge sensor) mounted on the left edge of door 18 and may include a second sensor such as a second one of sensors 42 (sometimes referred to as a right edge sensor) mounted to the right edge of door 18. Door 18 may also have an outwardly facing sensor such as sensor 60 (e.g., a capacitive proximity sensor such as a self-capacitance proximity sensor and/or a capacitive touch sensor, which may be implemented using an electrode that is attached to or formed within door 18 and/or using an electrode that is implemented using a metal portion of a door panel forming the exterior of door 18). Touch sensors may be used to sense user touch. Proximity sensors may be used to detect a user's arm, hand, finger, thumb, or other body part when the body part is not directly contacting the proximity sensor. During operation, capacitive sensors such as proximity sensors and/or touch sensors may be used to determine when a user is in proximity to vehicle 10 and/or when a user is touching vehicle 10. Sensors such as these (e.g., sensor 60) may be formed from an exterior conductive portion of door 18, may be mounted to the exterior of door 18, etc.

Initially, door 18 may be in a stowed position within an opening in vehicle body 12 as shown in FIG. 5. In this position, the door edge sensors (sensors 42 in the FIG. 5 example) may be hidden and may face opposing surfaces of body 12. As a result, sensors 42 cannot be viewed or contacted by the user.

After door 18 is unlocked, door 18 may be moved to the deployed position shown in FIG. 6. In this position, the door edge sensors 42 are visible to the user and can be reached by the user. For example, the user may press on the right or left door edge sensor with one or more fingers. Because door 18 is proud of body 12, door 18 can be slid to the side to open door 18 (e.g., door 18 may have structures that slide within a track in body 12).

As shown in FIG. 7, for example, a user may place a finger at location 64 on the right-hand door edge sensor 42 and can apply force to the left in direction 62. The right door edge sensor detects the applied force and moves door 18 to the left (using actuator 40). During leftward movement of door 18, the left door sensor or other sensor may detect when an external object such as object 61 is contacted by or nearly contacted by door 18 and can automatically prevent door 18 from moving further in response to detecting this obstruction.

The door opening process may be continued until door 18 is opened completely as shown in FIG. 8. Once door 18 has been slid fully to the left and is open (e.g., when door 18 no longer covers the door opening in vehicle body 12), the user can remove the finger at location 64 from the right door edge sensor.

If the user enters vehicle 10, the user can use an internally mounted button or input device to supply a close command that automatically closes door 18. If the user remains outside vehicle 10, the user can use the left door edge sensor to close door 18 in a manner similar to the opening operations of FIGS. 7 and 8. As shown in FIG. 9, for example, the user may press the user's finger at location 64 against the left door edge sensor 42. Door 18 (e.g., a door panel formed from metal, polymer, and/or other material) is then moved to the right in direction 65 in response to user body part pressure on the left door edge sensor 42 (e.g., pressure from a user's finger, thumb, hand, and/or other body part). As with the door opening operations of FIGS. 7 and 8, the velocity at which actuator 40 of door 18 moves door 18 to the right may, if desired, track the velocity of the user's finger, thumb, hand, or other body part applying the pressure to sensor 42. If the user increases the speed of movement of the finger, thumb, hand, or other body part in direction 65, the force applied by the finger, thumb, hand, or other body part will tend to increase, at which point door 18 can be moved more quickly to help reduce this force and thereby maintain the applied force at or near to a desired target amount of force. By using force input to control the speed of door opening and closing operations, door movement may smoothly track the user's movement of the user's finger, thumb, hand, or other body part. If desired, other arrangements may be used in adjusting the speed of door opening and closing (e.g., opening and closing velocities may be constant, door velocity may have a non-linear dependance on force input, etc.). In some embodiments, vehicle 10 may contain a tilt sensor that determines when vehicle 10 is parked on a sloped surface. By measuring tilt, the door actuator can respond so as to compensate for the effects of gravity while door 18 is being opened and closed. This may help ensure that door 18 opens and closes approximately the same way regardless of whether vehicle 10 is parked on a flat or sloped surface.

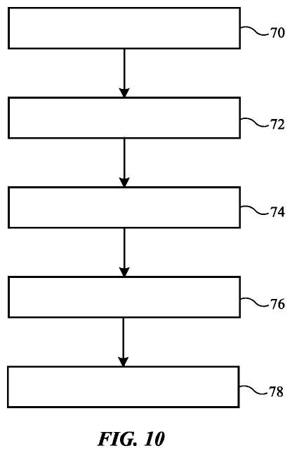

FIG. 10 is a flow chart of illustrative operations involved in opening and closing vehicle doors in vehicle 10.

During the “unlock” operations of block 70, door 18 may be unlocked. For example, vehicle 10 may use a sensor to detect when a user desires to unlock door 18. The sensor may be a camera with user tracking and/or facial recognition capabilities that tracks a user's movement towards vehicle 10 to confirm that vehicle 10 is the vehicle that the user intends to unlocked, a proximity sensor that detects when the user is in proximity to vehicle 10, a touch sensor that gathers user touch input, a force sensor that gathers user force input, a button that detects button press input, an optical sensor, a capacitive sensor, a biometric sensor, and/or other sensor. Door 18 may also be unlocked in response to user input from a user inside vehicle 10 (e.g., user input provided to a button, touch sensor, and/or other input device in the interior of vehicle 10). If desired, wireless circuitry (e.g., UWB circuitry that includes a UWB receiver, Bluetooth® circuitry, wireless local area network circuitry, near-field communications circuitry, and/or other wireless circuitry) may monitor for the presence of radio-frequency signals emitted by a device associated with the user. The user's device may be a key fob, watch, cellular telephone, or other device that emits radio-frequency signals that direct vehicle 10 to unlock door 18. Door 18 may be configured to unlock in response to receipt of these wireless signals.

Door 18 may have an externally facing sensor such as sensor 60. Sensor 60 may be a proximity sensor. Proximity measurements from sensor 60 can be used to determine when a person is near to door 18. In response to determining that a person is near to door 18, exterior lighting (e.g., a light-emitting diode light source of other light source) may be turned on to illuminate an area near door 18.

During the “deploy door” operations of block 72, door 18 may be deployed by moving door 18 from its stowed position (flush with body 12) to its unstowed position (a deployed position where door 18 is proud of body 12 and is ready to be slid parallel to the side of vehicle to open door 18). Door 18 may be deployed automatically upon unlocking of door 18, may be deployed when user input is provided to an input device in vehicle 10 (e.g., a touch sensor), may be deployed when sensor 60 (e.g., a proximity sensor) determines that the user is near to door 18 or when wireless signals are detected by the wireless circuitry of vehicle 10 that indicate that a user is in proximity to vehicle 10 (e.g., when it is detected that the user is sufficiently close to vehicle 10 to reach or nearly reach door 18), may be deployed when a user reaches for door 18 (as detected, for example, by a capacitive proximity sensor, optical proximity sensor, an image sensor in a camera system with hand tracking, etc.), and/or may be deployed in response to detection of other conditions using the sensor circuitry of vehicle 10. If desired, the speed with which door 18 is deployed (or otherwise moved) may vary as a function of the measured distance between a user's hand and door 18 and/or as a function of the measured speed at which the user's hand is measured to approach door 18). The velocity of deployment of door 18 may, as an example, be varied using hand distance and/or velocity measurements made using a capacitive proximity sensor (e.g., sensor 60).

Deployment of door 18 exposes sensors 42 at the left and right sides of door 18. During the operations of “open door” block 74, a user may press against an appropriate one of sensors 42 to open door 18. For example, if door 18 opens to the left, the user may press to the left on a right door edge sensor 42 that is mounted on the right edge of door 18. Door 18 may then move to the left. Sensor 42 may make touch and/or force measurements as the user touches sensor 42 during door opening. Measurements from sensor 42 may be used in determining how to control the velocity of door 18 as door 18 opens. Door 18 may be opened with a constant velocity, a velocity that tracks the velocity of the user's finger (e.g., so that a user may accelerate door movement by pressing harder on sensor 42), a velocity that tracks a user's finger until a predetermined velocity is reached (after which the velocity of door 18 may be held constant until door 18 is fully open, with or without requiring constant contact and/or pressure from the user's finger after the predetermined velocity is reached), a velocity that exhibits a non-linear response to measured finger force from the user, and/or a velocity that varies depending on other factors. If the user desires to stop movement of door 18 (when opening or when closing), the user may, in some embodiments, remove finger 62 from sensor 42, the user may supply input to sensor 60 (e.g., the user may move the user's hand near to a proximity sensor on door 18 that detects when a user's hand or other body part is close to door 18 and vehicle 10), the user may supply touch input to a touch sensor on door 18 (which may be formed from a capacitive sensor electrode that covers part of door 18 such as a self-capacitance sensor with a mesh-shaped metal electrode or a capacitive sensor electrode formed from door 18 itself), or the user may supply user input to another input device in vehicle 10 to direct door 18 to stop moving. In configurations in which sensor 60 is a proximity sensor and door 18 has been placed in motion by a button press or touch sensor input, the velocity of door 18 may, if desired, be reduced when sensor 60 detects that a person is about to touch door 18.

When it is desired to close door 18, user input may be supplied to a door close button or other input device (e.g., a button, touch sensor, force sensor, and/or other sensor on the interior or exterior of vehicle 10) and/or user input may be supplied to an appropriate door edge sensor mounted on the edge of door 18 as shown by “close door” block 76. As an example, a user may press to the right on a left-hand door edge sensor 42 to move door 18 to the right to close door 18. As with the door opening operations of block 74, door 18 may be closed with a constant velocity, a velocity that tracks the motion of the user's finger, a velocity that tracks the user's finger until a predetermined velocity is reached (after which the velocity of door 18 may be held constant until door 18 is fully closed, with or without requiring constant contact and/or pressure from the user's finger after the predetermined velocity is reached), a velocity that exhibits a non-linear response to measured finger force from the user, and/or a velocity that varies depending on other factors.

Door 18 may be stowed during the operations of “stow door” block 78 (which may sometimes be referred to as door closing operations and/or door stowing operations). For example, once door 18 has been slid over the opening in body 12, door 18 may be stowed by using actuator 40 to pull door 18 inward from position 18′ (FIG. 3) to a stowed position in which door 18 is flush with body 12. In some embodiments, door 18 may stow itself immediately upon sliding into position over the door opening in body 12. If desired, upon sliding into position 18′, door 18 may rest in position 18′ (FIG. 3) to await further user input (e.g., touch input, gesture input, force input, and/or other input to a sensor on door 18). When this user input is received, door 18 may then move into its stowed position.

Although sometimes described in connection with door edge sensors that are mounted on opposing door edges, the door open/close sensors for door 18 may, if desired, be located in other suitable locations such as portions of the exterior surface of door 18 near to the edges of door 18. For example, first and second sensors for door 18 may be provided at respective first and second locations on the outwardly facing surface of the door that is visible when door 18 is closed. Such locations may, as an example, be located near the left and right edges of door 18 (e.g., the first and second sensors may be left and right sensors mounted within 0.2 m or within 0.1 m of the left and right edges of door 18, respectively). In arrangements such as these, the left sensor may be located to the left of a door centerline and the right sensor may be located to the right of the door centerline (e.g., the left sensor is closer to the left edge than the right sensor and vice versa). In some embodiments, the first and second door sensors may be located nearer the center of door 18 (e.g., on opposing left and right sides of the door centerline) and/or at other suitable locations on door 18 (e.g., locations on the outside surface of door 18 away from the door edges). If desired, door 18 may be a gullwing door, a scissor door, a door that opens and closes vertically (e.g., a hatchback rear door), etc. In arrangements such as these, first and second door sensors may be located respectively at or near opposing upper and lower door panel edges rather than at or near left and right door panel edges.

The foregoing is merely illustrative and various modifications can be made to the described embodiments. The foregoing embodiments may be implemented individually or in any combination.

What is claimed is:

1. A mobile system, comprising:
a door having first and second opposing edges, having an actuator, having a first sensor at or near the first edge, and having a second sensor at or near the second edge, and
a mobile systems body having a door opening that is configured to receive the door, wherein the actuator is configured to slide the door in a first direction in response to input gathered with the second sensor and is configured to slide the door in a second direction that is opposite the first direction in response to input gathered with the first sensor.

2. The mobile system defined in claim 1, wherein the first edge comprises a left edge, wherein the second edge comprises a right edge, wherein the first sensor comprises a left edge sensor on the left edge of the door, wherein the second sensor comprises a right edge sensor on the right edge of the door, wherein the first direction is left, wherein the second direction is right, and wherein the left door edge sensor comprises a left force sensor and wherein the right door edge sensor comprises a right force sensor.

3. The mobile system defined in claim 2 wherein the right force sensor is configured to measure leftward force towards the door and wherein the left force sensor is configured to measure rightward force towards the door.

4. The mobile system defined in claim 3 wherein the right door edge sensor comprises a first capacitive touch sensor and wherein the left door edge sensor comprises a second capacitive touch sensor.

5. The mobile system defined in claim 3 further comprising an exterior sensor on an exterior surface of the door, wherein the actuator is configured to stop sliding of the door in response to input to the exterior sensor.

6. The mobile system defined in claim 4 wherein the exterior sensor comprises a capacitive sensor.

7. The mobile system defined in claim 6 wherein the capacitive sensor comprises an electrode formed at least partly from a metal door panel.

8. The mobile system defined in claim 6 wherein the capacitive sensor comprises a touch sensor.

9. The mobile system defined in claim 6 wherein the capacitive sensor comprises a proximity sensor.

10. The mobile system defined in claim 1 further comprising wireless circuitry configured to monitor for radio-frequency signals, wherein the door has a lock that is configured to unlock in response to receipt of the radio-frequency signals.

11. The mobile system defined in claim 1 further comprising an exterior sensor on the door, wherein the actuator is configured to move the door from a stowed position in which the door is flush with the mobile systems body to a deployed position based on information gathered by the exterior sensor.

12. The mobile system defined in claim 11 wherein the exterior sensor comprises a capacitive sensor.

13. The mobile system defined in claim 11 wherein the exterior sensor comprises a capacitive proximity sensor.

14. The mobile system defined in claim 1 further comprising a proximity sensor, wherein the actuator is configured to adjust a speed of movement of the door based on information from the proximity sensor.

15. A vehicle, comprising:
a door having an actuator and having a force sensor; and
a vehicle body having a door opening that is configured to receive the door, wherein the actuator is configured to move the door based on a force measurement gathered by the force sensor.

16. The vehicle defined in claim 15 wherein the actuator is configured to move the door at a velocity that increases in response to increases in the force measurement.

17. The vehicle defined in claim 16 wherein the actuator is configured to slide the door relative to the vehicle body.

18. The vehicle defined in claim 17 wherein the force sensor is located on an edge of the door.

19. A door for a vehicle that has a door opening, comprising:
a door panel that is configured to move between a closed position in which the door panel covers the door opening and an open position in which the door panel does not cover the door opening; and
a sensor;
an actuator, wherein the actuator is configured to move the door panel until the sensor detects an interruption in sensor input.

20. The door defined in claim 19 wherein the sensor comprises a force sensor.

21. The door defined in claim 20 wherein the actuator is configured to slide the door panel at a non-zero velocity while the force sensor is receiving non-zero force input and is configured to stop sliding of the door panel in response to detection of no force input with the force sensor.
